(19) United States
(12) Patent Application Publication
(10) Pub. No.: US 2025/0279953 A1
(43) Pub. Date: Sep. 4, 2025

(54) METHODS, SYSTEMS AND COMPUTER READABLE MEDIA FOR TESTING A SYSTEM UNDER TEST (SUT) USING PATH ADDRESSING

(71) Applicant: Keysight Technologies, Inc., Santa Rosa, CA (US)

(72) Inventors: Venkateshwar Rao Pullela, San Jose, CA (US); Ram Periakaruppan, Agoura Hills, CA (US)

(21) Appl. No.: 18/591,274

(22) Filed: Feb. 29, 2024

(51) Int. Cl. H04L 43/50; H04L 43/065

(52) U.S. Cl. CPC H04L 43/50; H04L 43/065

(57) ABSTRACT

A method for testing a system under test (SUT) using path addressing, the method comprising: at a test system implemented using at least one processor: generating test traffic for testing a SUT, wherein the test traffic includes a first set of test packets for triggering a test scenario or event at an area of interest (AOI) associated with the SUT, wherein at least one test packet of the first set of test packets includes encoded path addressing information indicating hops or links that the packet traverses prior to reaching a packet destination, wherein one of the hops or links includes the AOI; sending, via or toward the SUT, the test traffic; receiving, via one or more test related entities, test feedback information regarding the test traffic, the AOI, or the SUT; analyzing, using the test feedback information, performance of the SUT; and generating test results including at least one performance metric associated with the SUT.

### TECHNICAL FIELD

The subject matter described herein relates to testing network equipment or related behavior. More particularly, the subject matter described herein relates to methods, systems, and computer readable media for testing a system under test (SUT) using path addressing.

### BACKGROUND

Network operators typically test network nodes before deploying the network nodes to production networks (e.g., non-test environments). Generally, it is important to test networks nodes with varying traffic amounts and different types of traffic. For example, a test platform, such as an IxNetwork™ platform manufactured by Keysight, may be usable for network topology testing and traffic analysis and may generate test traffic for testing various network nodes using one or more protocols.

Data centers may refer to distributed systems (e.g., servers, switches, and/or other devices in one or more locations) usable for performing various functions. Within a data center, some nodes may perform centralized functions (e.g., services or microservices, like authentication or data access) involved with handling user traffic or providing services to users. Generally, east-west traffic may refer to intra-data center traffic (e.g., traffic within the data center or nodes thereof) and north-south traffic may refer to traffic that traverses the data center from or to a system physically residing outside the data center, e.g., traffic to or from a user.

While a test platform may attempt to perform testing of a data center, issues can arise when testing data center or distributed system in various scenarios, including scenarios with different traffic types and/or background traffic (e.g., traffic unrelated to testing or traffic from other tenants).

### SUMMARY

The subject matter described herein includes methods, systems, and computer readable media for testing a system under test (SUT) using path addressing. An example method for testing a SUT using path addressing, the method comprising: at a test system implemented using at least one processor: generating test traffic for testing a SUT, wherein the test traffic includes a first set of test packets for triggering a test scenario or event at an area of interest (AOI) associated with the SUT, wherein at least one test packet of the first set of test packets includes encoded path addressing information indicating hops or links that the packet traverses prior to reaching a packet destination, wherein one of the hops or links includes the AOI; sending, via or toward the SUT, the test traffic; receiving, via one or more test related entities, test feedback information regarding the test traffic, the AOI, or the SUT; analyzing, using the test feedback information, performance of the SUT; and generating test results including at least one performance metric associated with the SUT.

An example system for testing a SUT using path addressing includes at least one processor, a memory, and a test system implemented using the at least one processor and the memory. The test system is configured for: generating test traffic for testing a SUT, wherein the test traffic includes a first set of test packets for triggering a test scenario or event at an AOI associated with the SUT, wherein at least one test packet of the first set of test packets includes encoded path addressing information indicating hops or links that the packet traverses prior to reaching a packet destination, wherein one of the hops or links includes the AOI; sending, via or toward the SUT, the test traffic; receiving, via one or more test related entities, test feedback information regarding the test traffic, the AOI, or the SUT; analyzing, using the test feedback information, performance of the SUT; and generating test results including at least one performance metric associated with the SUT.

The subject matter described herein may be implemented in software in combination with hardware and/or firmware. For example, the subject matter described herein may be implemented in software executed by a processor. In one example implementation, the subject matter described herein may be implemented using a computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, and application-specific integrated circuits. In addition, a computer readable medium that implements the subject matter described herein may be located on a single device or computing platform or may be distributed across multiple devices or computing platforms.

As used herein, the term “node” refers to a physical node (e.g., at least one computing platform including one or more processors and memory) or a virtual node (e.g., a virtual machine (VM) or container running on a computing platform including one or more processors and memory).

As used herein, each of the terms “function”, “engine”, and “module” refers to hardware, firmware, or software in combination with hardware and/or firmware for implementing features described herein.

### BRIEF DESCRIPTION OF THE DRAWINGS

Embodiments of the subject matter described herein will now be explained with reference to the accompanying drawings, wherein like reference numerals represent like parts, of which:

FIG. 1 is a block diagram illustrating an example test system for testing a system under test (SUT) using path addressing;

FIG. 2A is a block diagram illustrating an example Ethernet frame;

FIG. 2B depicts example SUT information usable for encoding path addressing information;

FIG. 2C is a block diagram illustrating example path addressing information;

FIG. 3 is a block diagram illustrating an example test environment comprising network nodes that support path addressing;

FIG. 4 illustrates example path addressing information and related processing;

FIG. 5 depicts a message flow diagram related to testing a SUT; and

FIG. 6 is a flow chart illustrating an example process for testing a SUT using path addressing.

### DETAILED DESCRIPTION

The subject matter described herein includes methods, systems, and computer readable media for testing a system under test (SUT) using path addressing. When testing a SUT (e.g., a data center environment or network), a test operator may need to simulate traffic or network conditions (e.g., latency, drops, etc.) at one or more areas of interests (e.g., certain links, network nodes, etc.) to determine how the SUT or portions thereof behave. While a testing platform or a traffic generator thereof may be configured to send different types of traffic to or through the SUT, it may be tedious or cumbersome to direct test traffic (e.g., internet protocol (IP) traffic) to traverse certain areas without significant modifications (e.g., implementing routing rules or other routing mechanisms) in the test environment, especially if the test environment or elements thereof use destination based routing.

Path addressing, also referred to herein as path routing, allows a data packet sender to dictate either partially or entirely the path (e.g., a sequence of hops or links) the packet traverses to reach a destination. Unlike conventional routing, where routers make incremental decisions based on the packet's destination, path addressing gives control over the route taken by the packet to the sender. For example, in some embodiments described herein, to allow or support path routing, a packet may include path addressing information comprising local link or node identifiers (and optionally action identifiers) encoded to form a path vector or sequence. In this example, the path addressing information may be stored in an Ethernet or layer 2 header field or parameter, such as a destination media access control (MAC) field or other header fields. Continuing with this example, elements that are path routing enabled or supported may access and use the path addressing information (e.g., a next hop or an egress link identifier) in making forwarding decisions.

In contrast to path addressing as described above, a source-routed IP packet may include next-hop IP addresses in a specific field or parameter within the packet's IP header. The exact location of this field can depend on the specific protocol or method used for source routing. In the context of traditional IP source routing, next-hop IP addresses may be stored in the IP options field, where each IP router along the path may process this information and forward the packet to the next specified hop.

In accordance with some aspects of the subject matter described herein, techniques, methods, or mechanisms are disclosed for testing a SUT using path addressing. For example, a test system in accordance with various aspects described herein may be configured for: generating test traffic for testing a SUT, wherein the test traffic includes a first set of test packets for triggering a test scenario or event at an AOI associated with the SUT, wherein at least one test packet of the first set of test packets includes encoded path addressing information (e.g., stored in a layer 2 header parameter) indicating hops or links that the packet traverses prior to reaching a packet destination, wherein one of the hops or links includes the AOI; sending, via or toward the SUT, the test traffic; receiving, via one or more test related entities, test feedback information regarding the test traffic, the AOI, or the SUT; analyzing, using the test feedback information, performance of the SUT; and generating test results including at least one performance metric associated with the SUT.

Advantageously, a test system in accordance with some aspects of the subject matter described herein may test and/or evaluate a SUT by using path addressing to simulate or trigger network conditions or scenarios. For example, a test system may generate and send test traffic that includes path addressing information for directing the traffic to an AOI (e.g., a core network switch of the SUT) for causing congestions or network degradation. In this example, a test system may send additional test traffic to or through the SUT and then compute metrics indicating how the SUT performs when that AOI is affected. As such, a test system in accordance with some aspects of the subject matter described herein may effectively evaluate the SUT when one or more AOIs are affected by test traffic directed to the AOIs using path addressing information.

Reference will now be made in detail to various embodiments of the subject matter described herein, examples of which are illustrated in the accompanying drawings. Wherever possible, the same reference numbers will be used throughout the drawings to refer to the same or like parts.

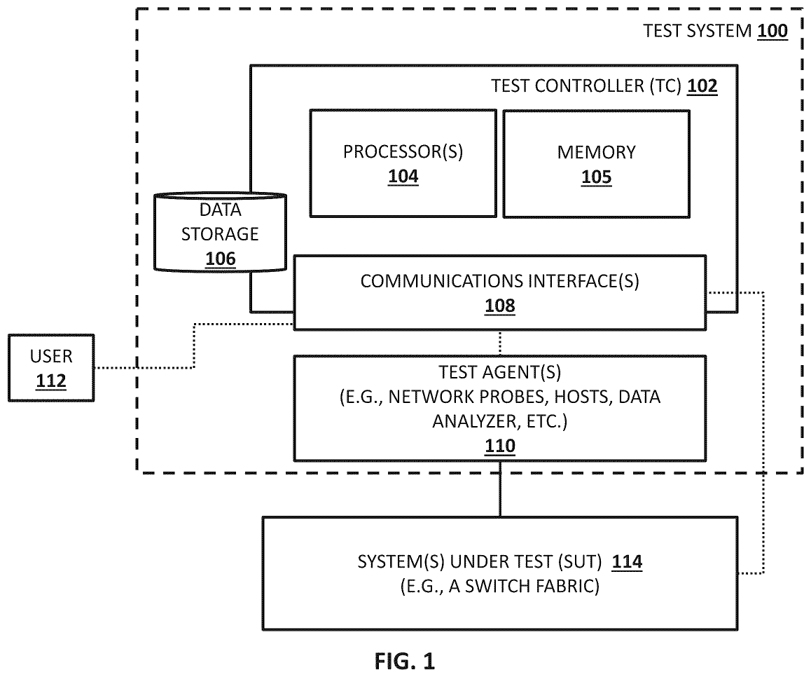

FIG. 1 is a block diagram illustrating an example test system 100 for testing a SUT using path addressing. Referring to FIG. 1, test system 100 may represent any suitable entity or entities (e.g., one or more testing platforms, nodes, or devices) associated with sending or receiving test traffic (e.g., one or more data units, messages, packets) and/or for testing a SUT 114 (e.g., a data center switching network, a group of network nodes, a network of switches, etc.) or aspects thereof (e.g., how the SUT or elements thereof handles congestion, link issues, switchover, etc.). For example, test system 100 or related entities may generate and send test traffic to or via SUT 114, e.g., one or more network switches, via one or more physical or virtual links. In this example, test system 100 or related entities may also receive test traffic, copies of test traffic, or test feedback information from SUT 114 or probes. Continuing with this example, test system 100 or related entities may use sent and/or received information to analyze performance aspects of SUT 114.

SUT 114 may include any suitable entity or entities (e.g., devices, cards, chips, systems, platforms, or software executing on one or more processors) for receiving, processing, forwarding, and/or sending one or more messages (e.g., packets). For example, SUT 114 may include a network, a switching fabric, a data center fabric, an enterprise network environment, a cloud services environment, or a cloud computing environment and may include various network nodes or elements, such network switches, routers, load balancers, etc. In another example, SUT 114 or an element thereof may include a network node, a network switch, a network router, a network interface card, a packet forwarding device, or a software based element. In some embodiments, SUT 114 or one or more element(s) thereof may include processing logic (e.g., rules associated with packet forwarding/processing) for forwarding traffic among a plurality of links or paths.

In some embodiments, SUT 114 may include a container or software in a virtual container (VC) or a virtual machine (VM) executing on shared resources (e.g., compute, storage, and network resources). For example, SUT 114 may include one or more network nodes or interconnected elements. In this example, an element of SUT 114 may be a container or related software acting as a switch or packet forwarding device and may execute on one or more of nodes or physical devices in a cloud or distributed environment.

In some embodiments, test system 100 may be a stand-alone tool, a testing device, a testing platform, or software executing on at least one processor. In some embodiments, test system 100 may be a single node or may be distributed across multiple computing platforms or nodes. In some embodiments, test system 100 may be capable of performing “one arm” and “two arm” type testing of SUT 114. For example, in “one arm” testing, test system 100 may configure a test session where a test system controller entity is handling one side of a communication session involving SUT 114 (e.g., acting as the sender of traffic) and, in “two arm” testing, test system 100 may configure a test session where test system controller entities are handling both sides of a communication session involving SUT 114 (e.g., acting as the sender and the receiver of traffic). In some embodiments, tests initiated by test system 100 may be performed in live or production network environments where live traffic is also transiting the SUT or in lab or test environments with only test traffic.

In some embodiments, test system 100 may include one or more modules for performing various functions or operations. For example, test system 100 may include a server and client emulation module for emulating a node or device that communicates with SUT 114.

Test system 100 may include a test controller 102 and one or more test agent(s) 110. Test controller 102 may be any suitable entity or entities (e.g., software executing on a processor, an application-specific integrated circuit (ASIC), a field-programmable gateway array (FPGA), or a combination of software, an ASIC, or an FPGA) for performing one or more aspects associated with test session configuration or test management. In some embodiments, test controller 102 may include logic or software executing on processor(s) 104 and may utilize data storage 106.

Test controller 102 may include one or more processor(s) 104 and a memory 105. Processor(s) 104 may represent or include a physical processor, a general purpose microprocessor, a single-core processor, a multi-core processor, an FPGA, and/or an ASIC for executing software and/or logic stored in memory 105. Memory 105 may represent one or more computer readable media (e.g., random access memory (RAM)) for storing data, logic, or other information.

Data storage 106 may be any suitable entity or entities (e.g., a storage device, a non-transitory computer readable medium, or a storage system) for maintaining or storing information related to testing SUT 114 and/or related metrics. In some embodiments, data storage 106 may include local storage as well as public or private remote repositories, e.g., GitHub. In some embodiments, data storage 106 may contain traffic models, test cases, test session data, test configuration information, configuration information for SUT 114, analytics, computed metrics, test packet data, link or node mapping information for encoding path addressing information, logic for obtaining and generating test traffic to areas of interests using path addressing, and/or other information. In some embodiments, data storage 106 may be located at or accessible by test system 100, test controller 102, another node, or distributed across multiple platforms or devices.

Communications interface(s) 108 may represent any suitable entities (e.g., network interface cards (NICs), port modules, and/or other hardware or software) for receiving and sending communications via various communications protocols and/or data formats. For example, communications interface(s) 108 may include a user interface (UI), a graphical UI (GUI), and/or an application programming interface (API) for allowing user 112 or another entity to provide configuration information and/or interact with test system 100. In another example, communications interface(s) 108 may include APIs or other interfaces to communicate with SUT 114 and/or test system components, e.g., test agent(s) 110. In this example, communications interface(s) 108 may be usable for providing configuration information (e.g., instructions) for configuring entities, e.g., prior to or during testing.

In some embodiments, test system 100 or a related entity (e.g., test controller 102) may provide a user interface (e.g., communications interface(s) 108) for a user 112 (e.g., a test operator) and/or another entity to interact with test system 100 or provide configuration information or other input. In some embodiments, a user interface associated with test system 100 may support automation (e.g., via one or more scripting languages), a representation state transfer (REST) API, a command line, and/or a web-based GUI. For example, user 112 may be any entity (e.g., an automated system or a device or system controlled or controllable by a human user) for selecting and/or configuring various aspects associated with configuring and/or executing one or more tests or test sessions. In this example, user 112 may utilize a management application user interface (API) and/or a graphical user interface (GUI)) for providing test configuration information, such as a test session plan or definition, test traffic template information, performance metrics to be computed, environment settings, network topology, etc.

As indicated above, configuring a conventional test system to execute test sessions that create or cause certain traffic or network conditions with precision (e.g., congestion in SUT 114 or a switching fabric thereof) can be difficult since routing decisions are somewhat dynamic in nature since egress links are selected on-the-fly at each switching hop based on the routing algorithms employed and operational conditions at the time that each routing decision is made.

In some embodiments, test system 100 may leverage path addressing for testing behaviors and/or performance of SUT 114 under various operational or traffic conditions. For example, test system 100 or a related entity may generate link-encoded path addressed test packets or flows to precisely target an AOI (e.g., a link, a LAG, node(s), etc.) in a switching fabric. In this example, by exposing an AOI (e.g., specific SUT switching element(s)) to precise test traffic conditions or test scenarios, test system 100 may test SUT 114 or related performance while these particular conditions or scenarios are occurring (which can be especially useful for testing failover or throughput performance during suboptimal conditions).

In some embodiments, test system 100, test controller 102, or another thereof may include functionality for receiving, obtaining, or deriving link or node identifier mappings for elements of SUT 114 or a related test environment. For example, a link or node identifier may refer to an identifier associated with an individual physical or virtual communication link, an identifier associated with a group of physical or virtual communication links (e.g., a LAG), or an identifier associated with one or more nodes (e.g., switching elements). In this example, each link or node identifier may be compressed or encoded to efficiently convey the link or node (e.g., a link locally known as ‘SW23-BC44563423’ may be represented by one or two nibbles, such as ‘3F’, in an encoded path addressed test packet).

In some embodiments, a link or node identifier may also be usable to indicate a handling or processing action that can be performed by a hop or intermediate node. Example processing actions may include, but are not limited to, copying a packet, modifying the packet, re-routing via an alternative link or path, dropping the packet, or converting the packet to a “non-path addressed” format. For example, a converted packet may include conventional routing address information (e.g., source and destination IP address information, etc.) and has the appropriate packet header parameters set to indicate that “regular” (e.g., non-Path) addressing is to be used.

Test agent(s) 110 may be any suitable entity or entities (e.g., software executing on a processor, an ASIC, an FPGA, or a combination of software, an ASIC, or an FPGA) for performing one or more aspects associated with testing or monitoring SUT 114. For example, test agent(s) 110 may be configured for generating and sending test traffic or executing test sessions, test cases, or test scenarios (e.g., a source host or related device); receiving and/or responding to test traffic (e.g., a destination host or related device); and/or analyzing data received in packets and/or stored in memory (e.g., a network tap, a probe, a data analyzer, etc.). In another example, test agent(s) 110 may include network tap or probe functionality (e.g., a visibility tool) and may deployed at or as elements in a test network or SUT 114.

In some embodiments, test agent(s) 110 may be standalone devices or platforms or may be deployed as software executing on other nodes or devices. In some embodiments, test agent(s) 110 may be configurable by test controller 102 or other test system entities. For example, test agent(s) 110 may receive configuration instructions (e.g., test traffic templates, tap settings, etc.) from test controller 102 or another source.

In some embodiments, test controller 102 may generate test session plan information (e.g., configuration instructions associated with a test session, path addressing information, test traffic profiles, feedback data to collect or derive, and reports or test performance information to generate) and may provision or provide the configuration instructions to various test system components, e.g., stand-alone or distributed test agent(s) 110. In this example, the configuration instructions may be communicated to various test system components via an external or internal communications channel or protocol.

In some embodiments, test system 100 or test controller 102 may also send instructions for configuring test agent(s) 110 and/or other test system components to provide test feedback information to test system 100 or a related entity. For example, configuration instructions may indicate what statistics, metrics, or metadata to collect about the test traffic or related nodes, responses to the test traffic, or related routing and when or how to provide this information to test system 100 or a related entity.

In some embodiments, test system 100, test controller 102, or another entity may include functionality for initiating or executing a test session plan. For example, test controller 102 may send configuration information associated with a test session plan to SUT 114 and various other entities (e.g., test agent(s) 110 or test traffic generation engines) to use link or node mapping information to construct test packets or flows that incorporate link-encoded path addressing information for testing SUT 114. In this example, link-encoded path addressing information or data therein (e.g., link identifiers) may be selected, for example, to implement a test traffic pattern for causing or triggering an incast congestion event, a latency event, or another network event or condition within SUT 114 (e.g., at an AOI). Continuing with this example, e.g., depending on test goals or objectives, various other test traffic and actions may occur.

Example test related actions may include generating and providing test feedback information (e.g., statistics or metrics), copying test traffic or related data and/or sending the copied test traffic or related data to test system 100, or generating and providing traffic distribution data or other test related data (e.g., traffic byte counters, packet counters, drop counters, congestion indicators, latency measurements (e.g., when the platform supports via in-band telemetry or another telemetry technique)).

In some embodiments, test agent(s) 110 may be located at traffic generators, an emulated or non-emulated user device, or another device (e.g., a physical or virtual source host) and may use configuration instructions to generate test traffic associated with a test session or related scenario and to insert encoded path addressing information into at least some of the test traffic before sending the test traffic toward a destination, e.g., SUT 114. In some embodiments, test agent(s) 110 may be deployed to monitor the test traffic in SUT 114 or to receive the test traffic and performing various processing or analysis, e.g., logging packets that were received along with metadata like receive timestamps.

In some embodiments, test system 100 may monitor and/or infer the performance of SUT 114 by analyzing various attributes or characteristics of test traffic sent into SUT 114 during a test system triggered event (e.g., a congesting event). For example, test system 102 or a test analyzer thereof may analyze test traffic received via a test system receive port to determine latency, jitter, dropped packets, etc.

In some embodiments, test system 100 or test controller 102 may deploy one or more monitoring agents, taps or probes in SUT 114 in order to collect SUT operational or performance data during execution of a test session or a test case. In such embodiments, SUT operational and performance data collected may be analyzed by test system 102 or a test analyzer thereof and used to produce one or more test metrics (e.g., average packet drop count, average latency, average jitter, average link failover time, etc.) or test result indicators (e.g., pass/fail, etc.).

In some embodiments, test system 100, test controller 102, or another entity (e.g., a test analyzer or a test agent at a destination host) may include functionality for analyzing test feedback information and provide test results or reports. For example, a test analyzer of test system 100 may receive test related data (e.g., test packets, timestamps, packet metrics, and/or SUT related metrics) and derive or compile easy to read or human comprehensible reports. For example, assuming test system 100 has access to information about test traffic sent via SUT 114 and test traffic that reached its destination, test system 100 or a related entity (e.g., a test analyzer) may compute performance aspects of SUT 114, e.g., packet drops, average latency, etc. In this example, test system 100 or a related entity (e.g., a test analyzer) may generate visuals, images, and/or graphs indicating performance changes over time, e.g., before, during, and after an incast congestion event caused by path addressed test packets.

It will be appreciated that FIG. 1 is for illustrative purposes and that various depicted entities, their locations, and/or their functions described above in relation to FIG. 1 may be changed, altered, added, or removed. It will be appreciated that test scenarios described herein are just a few examples that illustrate how the unique capabilities of test system 100 can be used to precisely focus particular types and amounts of test traffic on or at an AOI of SUT 114 (e.g., a specific SUT switching fabric element). It will be further appreciated that embodiments of test system 100 can be used to simultaneously focus particular types and amounts of test traffic on multiple specific nodes or elements in SUT 114, thereby enabling user 112 to execute more complicated tests on SUTs 114 of varying sizes and/or complexities.

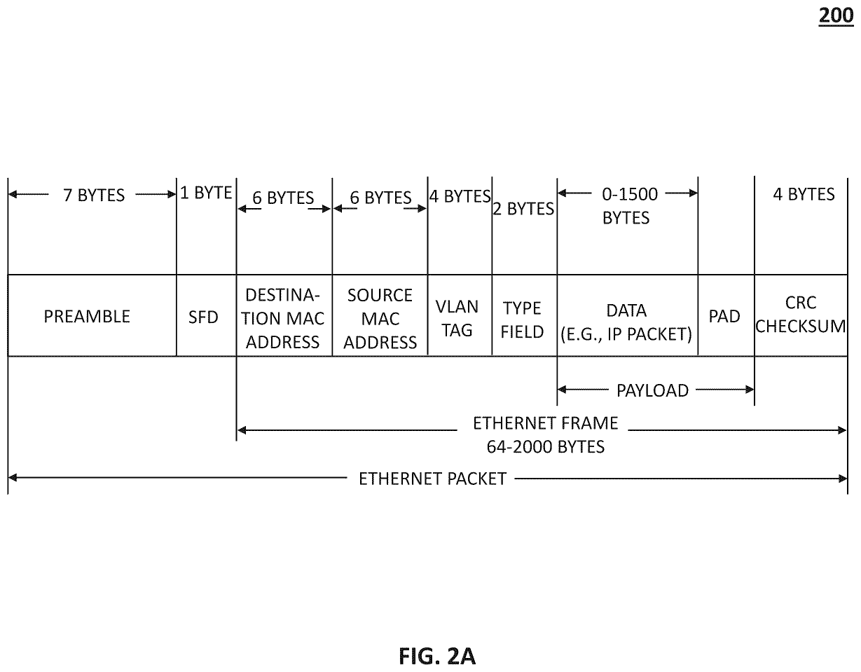

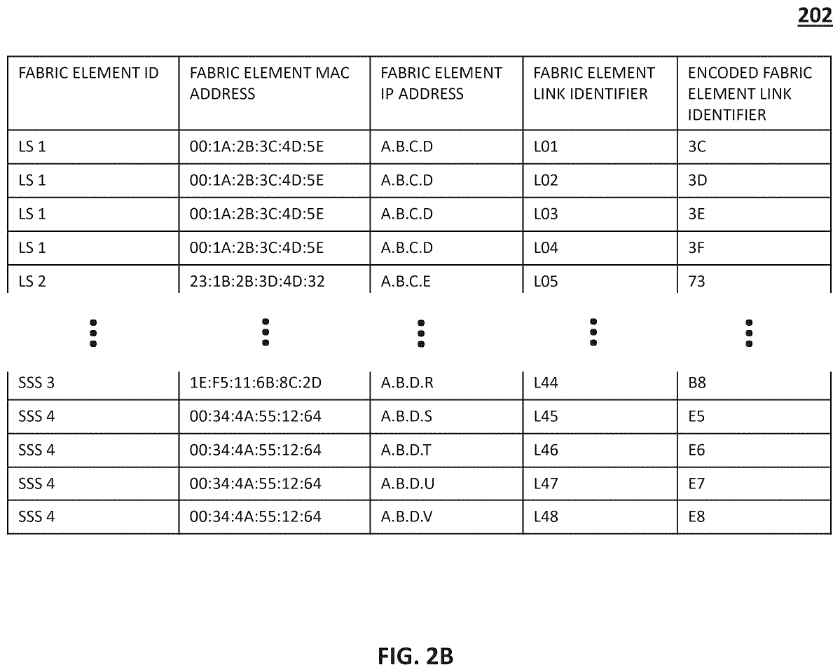

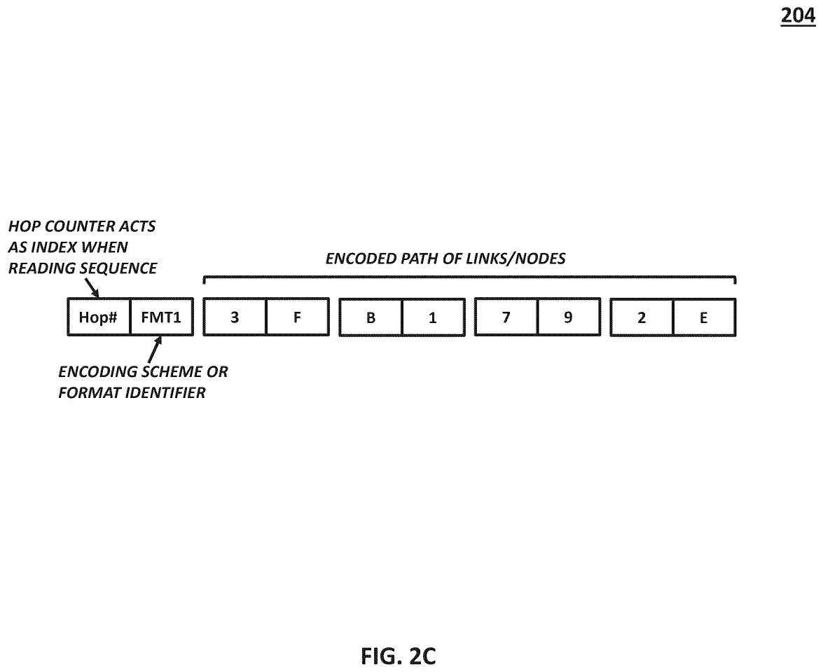

FIG. 2A is a block diagram illustrating an example Ethernet frame 200, also referred to herein as a packet 200. Packet 200 may include a preamble including seven bytes of data followed by the SFD including one byte. The frame begins after the SFD, which forms the remainder of packet 200. The frame includes a six-byte receiver media access control (MAC) address and a six-byte sender MAC address identifying unique addresses for the destination and source of the packet 200, respectively. Packet 200 may include an optional virtual local area network (VLAN) tag of four bytes if the packet 200 is traveling to or from a port handling more than one VLAN. Packet 200 may further include two bytes identifying a type field followed by a payload with a maximum length of 1500 bytes. The payload may include an IP packet and a padding field of variable length to ensure a minimum length of the payload or frame. The end of packet 200 may include a cyclic redundancy check (CRC) checksum of 4 bytes to detect accidental changes to the transmitted data. Packet 200 may have a maximum length of 2000 bytes.

It will be appreciated that packet 200 and portions thereof are for illustrative purposes and not all header parameters or packet configurations are depicted in packet 200. Further, it will be understood that other packets, data units, or traffic may be usable for testing SUT 114 and/or for containing path addressing information.

FIG. 2B depicts example SUT information 202 usable for encoding path addressing information. In some embodiments, SUT information 202 may include connection information, topology information and/or metadata regarding SUT 114 or elements thereof. In some embodiments, SUT information 202 or portions or variations thereof may be accessed and/or stored by test controller 102 and/or other entities using one or more data structures or storage devices (e.g., data storage 106).

In some embodiments, test system 100 or an entity thereof may obtain and/or derive SUT information 202 including SUT element link identifier information (e.g., physical and/or virtual link identifiers) via various techniques including, but not limited to: having user 112 may manually input or provide this information, communicating with SUT elements (e.g., via a SUT element's administrative or management APIs, etc.) to obtain the link identifier information, or communicating with a traffic engineering network controller or a network element management subsystem or controller, such as a software defined network (SDN) controller, an artificial intelligence or machine learning (AI/ML) scheduling controller, a cloud management subsystem, a orchestration subsystem, or other network administration subsystem that maintains network topology information that includes link identifier information, traffic engineering network controller, etc. In the case of an SDN controller (or a similar source of topology map or link identifier information), test system 100 or an entity thereof may establish communications and obtain the desired topology or link identifier information via an API provided by the source.

In some embodiments, test system 100 or an entity thereof may query or poll SUT elements or other sources of SUT information 202 in near real time, e.g., as a test case is being prepared for execution in order to obtain the necessary link identifier information. In some embodiments, SUT link identifiers may be obtained once, prior to execution of a test case, and statically maintained until a refresh is manually or automatically initiated.

Referring to FIG. 2B, SUT information 202 may be depicted using a table representing information about various fabric elements (e.g., switches or network nodes) or related links. For example, each row may represent a link in SUT 114 and may indicate related identifiers and other metadata, e.g., a fabric element identifier, a fabric element MAC address, a fabric element IP address, a fabric element link identifier, an encoded fabric element link identifier, etc.

In some embodiments, a fabric element identifier may include any suitable information for identifying a fabric element (e.g., a switch or network node of SUT 114) that a packet may traverse. For example, a fabric element identifier may be an integer, an alphanumerical value, or a string of characters that uniquely identifies a fabric element of SUT 114.

In some embodiments, a fabric element MAC address may include any suitable information for identifying a network interface of a fabric element and may be usable in routing or switching packets to a particular destination, e.g., layer 2 routing. In some embodiments, a fabric element may have one or more network interfaces for receiving or transmitting packets. For example, a fabric element MAC address may be 48 bits (i.e., 6 bytes) and expressed in hexadecimal notation.

In some embodiments, a fabric element IP address may include any suitable information for identifying a fabric element or a network interface of the fabric element and may be usable in routing or switching packets to a particular destination, e.g., layer 3 routing. In some embodiments, a fabric element may utilize one or more IP addresses for receiving or transmitting packets. For example, a fabric element IP address may be an IPv4 address (e.g., 32 bits) or an IPv6 address (e.g., 128 bits).

In some embodiments, a fabric element link identifier may include any suitable information for identifying a link (e.g., an egress or ingress link) or link aggregation group (LAG) of a fabric element (e.g., a switch or network node of SUT 114) and may be usable in routing or switching packets to a particular destination, e.g., layer 3 routing. In some embodiments, a fabric element may utilize one or more links for receiving or transmitting packets. For example, a fabric element link identifier may be an integer, an alphanumerical value, or a string of characters that identifies a link or LAG of SUT 114, e.g., locally unique identifiers.

In some embodiments, an encoded fabric element link identifier may include any suitable information for indicating a link (e.g., an egress or ingress link) or link aggregation group (LAG) of a fabric element (e.g., a switch or network node of SUT 114) and may be compressed and/or usable in an encoded path. For example, an encoded fabric element link identifier may uniquely identifies a particular fabric link or link identifier and may be a predetermined bit size (e.g., 4 bits).

It will be appreciated that SUT information 202 in FIG. 2B is for illustrative purposes and that different and/or additional information may also be stored or maintained. Further, it will be appreciated that SUT information 202 or related data may be stored in various data structures, memories, media, and/or in one or more locations.

FIG. 2C is a block diagram illustrating example path addressing information 204. In some embodiments, path addressing information 204 may be stored or located in one or more packet header parameters (e.g., a destination MAC field, a source MAC field, a VLAN tag, an Ethernet Type field, a CRC, etc.) or a payload. For example, as depicted in FIG. 2C, path addressing information 204 may be stored in an Ethernet header field that is at least 5 bytes, e.g., a destination MAC field. In another example, e.g., where a path involves a significant number of links or hops, path addressing information 204 may be stored among multiple Ethernet header fields (e.g., a destination MAC field and a source MAC field) or a particular portion of a payload. In another example, assuming packet 200 includes an IP packet in its payload, path addressing information may be inserted into an IP header parameter (e.g., a destination IP address) or into an IP payload.

In some embodiments, path addressing information 204 may indicate or convey a full or complete path. For example, in complete path routing, the entire path for a packet from source (or first switch after source device) to final destination (or last switch before user device) (e.g., each and every hop from source to final destination) may be specified by a link-encoded path sequence of path addressing information 204.

In some embodiments, path addressing information 204 may indicate or convey a partial path. For example, in partial path routing, only a portion of a packet's path source (or first switch after source device) to final destination (or last switch before user device) (e.g., each and every hop from source to final destination) may be specified by a link-encoded path sequence of path addressing information 204. In some partial path routing scenarios, a packet may contain information (e.g., a parameter value, flag, etc.) that serves to specify an action that should be taken by an intermediate fabric element that receives the packet when its hop counter value is zero.

In some embodiments, path addressing information 204 may be encoded and/or compressed to fit in a particular header parameter. For example, assume each link or LAG of SUT 114 may be uniquely identified by a nibble (e.g., four bits or 0.5 bytes), then a 6 byte sized parameter may be capable of storing a complete or partial path comprising a sequence of up to 12 hops. In another example, assume each link or LAG of SUT 114 may be uniquely identified by two nibbles (e.g., eight bits or 1 byte), then a 6 byte sized parameter may be capable of storing a complete or partial path comprising a sequence of up to 6 hops. In another example, assume each hop or link of a test environment is uniquely identified by a two bits (e.g., 0.25 bytes), then a 4 byte sized parameter may be capable of storing a complete or partial path comprising a sequence of up to 16 hops or links.

In some embodiments, the location and/or format of path addressing information 204 may be predetermined or known to various entities in a network or test environment, e.g., provided by a network operator or a management device. In some embodiments, the format of path addressing information 204 may be indicated by a format or scheme identifier in an expected location of packet 200, e.g., the second nibble of the first byte of the destination MAC address field value.

In some embodiments, e.g., when inserted in a test packet, path addressing information 204 may replace or reuse one or more header parameter values of the test packet. In such embodiments, an encoding or compression format or scheme may be usable to indicate where or how to find the replaced data. For example, if all six bytes of a destination MAC address field of packet 200 is needed to store path addressing information 204, when generating a test packet a traffic generator of test system 100 may compress or store the actual destination MAC address in another header field (e.g., a header field that is superfluous for the test scenario), in a payload, or may convey the actual destination MAC address as a virtual link or node identifier in the encoded path (which may be decoded using mapping information). In this example, a network node may be configured to know the encoding or compression format or scheme used or may detect the encoding or compression format or scheme of the test packet (e.g., using the format or scheme identifier in packet 200) and then use that knowledge to obtain or retrieve the actual destination MAC address if or when it is needed. In another example, two header fields like a destination MAC field and a source MAC field of packet 200 may be used to convey both path addressing information 204 and compressed or encoded versions of the destination MAC address and the source MAC address. In this example, a network node may be configured to know the encoding or compression format or scheme used or may detect the encoding or compression format or scheme of the test packet (e.g., using the format or scheme identifier in packet 200) and then use that knowledge to obtain or retrieve the actual destination MAC address and the actual source MAC address if or when they are needed.

In some embodiments, path addressing information 204 may include or indicate one or more actions to perform on a data packet (or data thereof) or at a hop along its path. For example, assume that each action of a set of actions (e.g., drop, packet copy, add latency, add a timestamp, compute a metric, etc.) is uniquely identified by one or more bits or that a link and action combination may be represented by multiple bits, then path addressing information 204 may indicate a complete or partial path for a packet along with actions at one or more hops along the path.

In some embodiments, path addressing information 204 or an encoded path therein may utilize local identifiers (e.g., identifiers that uniquely identifies a link, a node, or a LAG in a test environment by elements in the test environment or during a test session) or encoded versions thereof. For example, test system 100 or test controller 102 may assign or map the same local identifiers for different test sessions or test environments In some embodiments, path addressing information 204 and, as such, local identifiers may not be globally unique. In this example, by utilizing locally unique identifiers or related encoded identifiers, an encoded path may indicate multiple egress links or next hops in a relatively small number of bits, such as in a destination MAC field and/or a source MAC field.

In some embodiments, path addressing information 204 or an encoded path therein may utilize virtual link or node identifiers which can mapped to a physical or actual link or node in SUT 114 or a related test environment and/or may be mapped to action(s) or operation(s) to be performed on the packet, a LAG, or another routing or forwarding concept or entity for allowing routing or forwarding flexibility for testing various environments and scenarios. For example, a virtual link or node identifier value contained in a packet may be interpreted by a network node (e.g., an intermediate SUT fabric element or switch) using mapping information (e.g., provided by test controller 102 or from an accessible data store) and, in response to the virtual link or node identifier value, the network node may perform one or more packet handling or processing operations including, but not limited to, equal cost multi path (ECMP) routing, spraying (e.g., round-robin routing), trimming (e.g., truncating a portion of the packet), responding as if the link is down or as if there is congestion (e.g., notifying the other network nodes of such an event and performing related behaviors), causing congestion (e.g., by duplicating the packet until congestion is detected), causing latency, dropping the packet, etc.

In some embodiments, an explicit header parameter value may be included or set in a packet for conveying that an action that is to be performed by a network node (e.g., an intermediate SUT fabric element or switch). For example, a flag or parameter value in a encoded path addressed packet may be set to value “01”, which indicates that the packet should be dropped by a SUT switching fabric element that receives the packet when the hop counter value in the packet is zero. In contrast, in some other embodiments, a “hop counter value is zero” action may be encoded into path addressing information 204 (e.g., as a virtual link or node identifier) in a packet.

Referring to FIG. 2C, path addressing information 204 may include a hop counter value, a format or scheme identifier, and encoded path data. The hop counter may be a predetermined size (e.g., 4 bits) and at a predetermined location (e.g., a first nibble of a first byte) of path addressing information 204 or a related parameter. In some embodiments, the hop counter may indicate how many hops are left in the encoded path and/or a starting index of where a given link or hop identifier is found. For example, assume that every hop is encoded using 2 nibbles, a switch or other network node may be configured to use a hop count value (e.g., 8) to identify that the first 2 nibbles are to be read (e.g., by counting nibbles from left to right (e.g., the end of the field or parameter to the beginning of the field or parameter)) and may update the hop count value (e.g., by decrementing by 2) before sending the packet onward via a link identified by the two nibbles. In this example, a next hop may be configured to use the updated hop count value (e.g., 6) to identify that the next 2 nibbles are to be read (e.g., by counting nibbles from left to right) and may update the hop count value (e.g., by decrementing by 2) before sending the packet onward via a link identified by these two nibbles.

In some embodiments, a format or scheme identifier may be a predetermined size (e.g., 4 bits) and at a predetermined location (e.g., a second nibble of a first byte) of path addressing information 204 or a related parameter. In some embodiments, the format or scheme identifier may indicate which encoding scheme or format used for encoding path data (e.g., a sequence of link or node identifiers) or related information. For example, a format or scheme identifier may indicate the number of bits used for each hop/link identifier, how to decode the encoded path data, how to use the hop count value to identify the next link or hop data, which link data to use (e.g., SUT information 202), and/or which packet related actions can be indicated in the encoded path data. In some embodiments, the format or scheme identifier may indicate a class of service (CoS) identifier.

In some embodiments, encoded path data may be a predetermined size or a variable size (e.g., 1-12 bytes) and at a predetermined location (e.g., the second byte onward) of path addressing information 204 or a related parameter. In some embodiments, encoded path data may represent or indicate a sequence of links or nodes that a packet is to traverse and may optionally indicate one or more actions that are to be performed at one or more hops along the path. For example, as depicted in FIG. 2C, the encoded path ‘3FB1792E’ may indicate a sequence of four encoded link identifiers representing a partial or complete path that a packet should traverse within SUT 114. In this example, ‘3F’ may represent a first link, ‘B1’ may represent a second link, ‘79’ may represent a third link, and ‘2E’ may represent a fourth link.

It will be appreciated that path addressing information 204 and portions thereof are for illustrative purposes and not all encoding schemes or configurations are depicted in FIG. 2C.

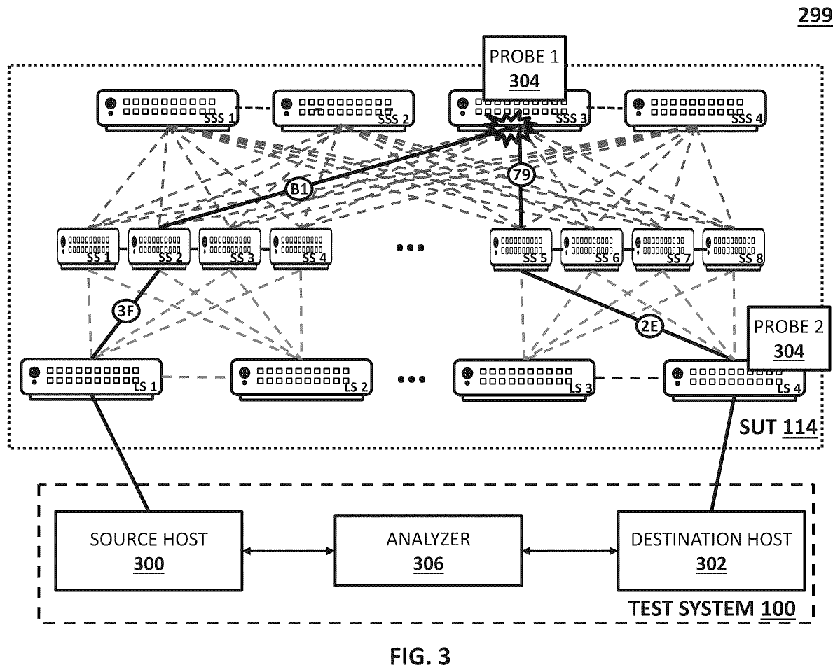

FIG. 3 is a block diagram illustrating an example test environment 299 comprising network nodes (e.g., switching elements of SUT 114) that support path addressing. Test environment 299 may include test system 100, SUT 114, or other entities (e.g., real or emulated devices, components, software, etc.) for testing SUT 114 using path addressing. In some embodiments, test system 100 may include a source host 300, a destination host 302, probes 304, analyzer 306 and/or other test related entities (e.g., test controller 102). For example, test system 100 may be implemented on a single test platform or test system 100 may be distributed across multiple platforms or devices.

In some embodiments, SUT 114 or element(s) thereof may support routing or forwarding using path addressing information. For example, as depicted in FIG. 3, SUT 114 may represent a data center fabric or environment comprising a switch architecture comprising leaf switches (e.g., LS 1-4), spine switches (SS 1-8), and super spine switches (SSS 1-4). In this example, each of these switches may be connected to one or more switches or other entities and may utilize path addressing information in a packet for routing or forwarding the packet along a specified path or portion of a path indicated by the path addressing information.

Source host 300 may represent any suitable entity (e.g., an emulated or non-emulated node or device, a test port, software executing on a processor, etc.) associated with sending or receiving test traffic (e.g., data units, messages, packets) and/or for testing a SUT 114. In some embodiments, e.g., prior to executing a test session, source host 300 or test agent 110 thereof may be configured (e.g., by test controller 102) for generating test traffic. For example, test controller 102 or a related entity may send instructions to source host 300 or test agent 110 thereof for generating a particular mix of test traffic with various test values or characteristics based on a test plan or user input. In this example, the instructions may also indicate that source host 300 or a related entity (e.g., hardware or a reporting function) is to send various data to analyzer 306 for analysis and/or test results generation.

Destination host 302 may represent any suitable entity (e.g., an emulated or non-emulated node or device, a test port, software executing on a processor, etc.) associated with sending or receiving test traffic (e.g., data units, messages, packets) and/or for testing a SUT 114. In some embodiments, e.g., prior to executing a test session, destination host 302 or test agent 110 thereof may be configured (e.g., by test controller 102) for handling test traffic and/or generating test results or related metrics. For example, test controller 102 or a related entity may send instructions to destination host 302 or test agent 110 thereof for indicating how test packets are to be processed and/or how metrics are to be computed. In this example, the instructions may also indicate that destination host 302 or a related entity (e.g., hardware or a reporting function) is to send various data to analyzer 306 for analysis and/or test results generation.

Probes 304 may represent any suitable entity (e.g., software executing on a processor or device, a stand-alone device, etc.) associated with monitoring traffic, copying packet data, and/or generating and reporting various traffic related metrics. For example, probes 304 may include kernel-probes, lightweight software agents, external taps, etc. In some embodiments, probes 304 may represent or include test agents 110 configured for performing tap or probe related functions and may be usable for directly or indirectly monitoring the performance of one or more SUT elements that are impacted by a triggered network event (e.g., an incast event). For example, prior to executing a test session, test controller 102 or a related entity may send instructions to probes 304 for indicating how test packets are to be copied or inspected and/or how metrics are to be computed. In this example, the instructions may also indicate that probes 304 or a related entity (e.g., hardware or a reporting function) are to send various data to analyzer 306 for analysis and/or test results generation.

Analyzer 306 may represent any suitable entity (e.g., an emulated or non-emulated node or device, software executing on a processor, etc.) associated with analyzing test results (e.g., packets, timestamps, metrics, etc.) and/or generating a report or related information associated with testing SUT 114 or related aspects. In some embodiments, e.g., prior to executing a test session, source host 300, destination host 302, probes 304, and/or other entities may be configured (e.g., by test controller 102) to send test results, derived metrics, feedback, or other information to analyzer 306. For example, test controller 102 or a related entity may send instructions to test agents 110 at hosts 300 and 302 for indicating how often and what type of data should be provided to analyzer 306. In this example, test controller 102 or a related entity may also send instructions to analyzer 306 indicating how data should be analyzed and/or how reports or analysis data should be reported or displayed.

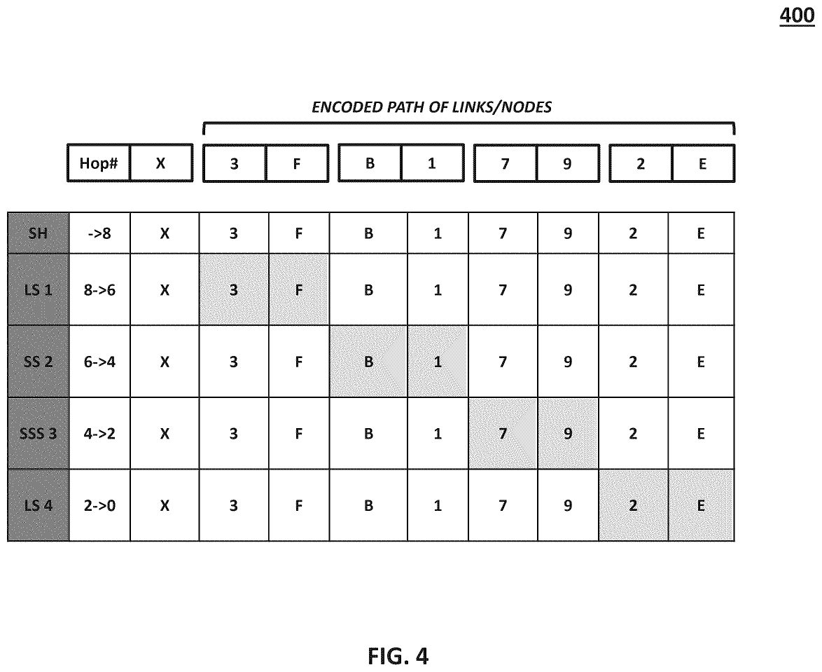

Referring to FIG. 3, each switch in SUT 114 may connected to various entities via links. For example, as depicted in FIG. 3, one link between LS 1 and SS 2 is represented by an encoded link ID of ‘3F’; one link between SS 2 and SSS 3 is represented by an encoded link ID of ‘B1’; one link between SSS 3 and SS 5 is represented by an encoded link ID of ‘79’; and one link between SS 5 and LS 4 is represented by an encoded link ID of ‘2E’. In this example, a packet containing an encoded path (e.g., a vector or sequence of four link identifiers (e.g., ‘3F’, ‘B1’, ‘79’, ‘2E’) in a destination MAC field) may enter the data center fabric at LS 1 from node A. At the first hop, LS 1 may determine or extract the first link identifier from the encoded path (e.g., ‘3F’), decrement the hop counter value, and forward the packet via an egress link represented by ‘3F’. It will be appreciated that the hop counter value in the packet is effectively used as an index into the encoded path. This encoded path processing may repeated by each switch along the path (e.g., a total of 4 times), until the packet has destination host 302. Additional details related to example encoded path processing are discussed below with regard to FIG. 4.

In one example use case, user 112 may configure a test session that involves creating an incast congestion event at a specific switching/routing element in SUT 114. In this example case, the specific SUT fabric switch being targeted is identified within the SUT as super spine switching element “SSS 3”. Using link-level topology information that is manually provisioned by user 112 or obtained from SUT 114, test system 100 or test controller 102 may configure source host 300 or a test packet generator thereof to create a large volume of test packets with encoded path data that causes the test packets to terminate at super spine switching element “SSS 3” (e.g., by indicating that “SSS 3” is the last hop). Continuing with this example, test system 100 or test controller 102 may also simultaneously generate non-path addressed test traffic (e.g., packets that use a traditional IP addressing scheme) that are destined for destination host 302 or locations that are reachable in or via SUT 114, thereby test system 100 can use path addressed test traffic to create precisely focused congestion at a SUT switching fabric element, while generating and directing other test traffic through SUT 114.

It will be appreciated that FIG. 3 is for illustrative purposes and that various depicted entities, their locations, and/or their functions described above in relation to FIG. 3 may be changed, altered, added, or removed. For example, in some embodiments, destination host 302 or an entity thereof may include analyzer 306 or provide similar functionality. In another example, in some embodiments, test controller 102 may act as analyzer 306 or provide similar functionality.

FIG. 4 illustrates a processing diagram 400 associated with example path addressing information comprising an encoded path of links or nodes. Processing diagram 400 includes rows of data, where each row represents how a particular node of SUT reads a portion of the encoded path indicated by a hop counter acting as an index into the encoded path.

In some embodiments, SUT 114 or elements thereof may be configured for reading and interpreting encoded path addressing information. For example, each switch of SUT 114 (e.g., as depicted in FIG. 3) may be configured to look for encoded path addressing information in a predetermined header parameter (e.g., a destination MAC field) and, if encoded path addressing information exists, the switch may be configured to determine the current hop count value (e.g., the first 4-8 bits of the parameter value) and using the current hop count value as a starting index and a predetermined number of bits (e.g., 8-16 bits) from the starting index of the encoded path to obtain the portion of the encoded path representing the next hop and, optionally, a packet related action to perform on the packet. In this example, each of the switches may use mapping information (e.g., from test controller 102, a data store, a test operator, or another entity) to decode the relevant portion of the encoded path and determine the next hop and, optionally, a packet related action to perform.

Referring to diagram 400, each row may represent the path taken by a test packet depicted in FIG. 3. For example, the first row of diagram 400 indicates that source host 300 sends a generated test packet via a predetermined link to LS 1 of SUT 114 and may indicate the hop count is 8 (representing that the encoded path is not yet read or used in routing). The second row of diagram 400 indicates that LS 1 receives the test packet, reads the first two nibbles of the encoded path (i.e., 3F) as indicated by the hop count value, and using the obtained data determines that the test packet should be sent via a particular link to a next hop (i.e., SS 2) and decrements the hop count value by 2 (i.e., from 8 to 6) before sending it onward. The third row of diagram 400 indicates that SS 2 receives the test packet, reads the next two nibbles of the encoded path (i.e., B1) as indicated by the hop count value, and using the obtained data determines that the test packet should be sent via a particular link to a next hop (i.e., SSS 3) and decrements the hop count value by 2 (i.e., from 6 to 4) before sending it onward. The fourth row of diagram 400 indicates that SSS 3 receives the test packet, reads the next two nibbles of the encoded path (i.e., 79) as indicated by the hop count value, and using the obtained data determines that the test packet should be sent via a particular link to a next hop (i.e., LS 4) and decrements the hop count value by 2 (i.e., from 4 to 2) before sending it onward. The fifth row of diagram 400 indicates that LS 4 receives the test packet, reads the next two nibbles of the encoded path (i.e., 2E) as indicated by the hop count value, and using the obtained data determines that the test packet should be sent via a particular link to a next hop (i.e., destination host 302) and decrements the hop count value by 2 (i.e., from 2 to 0) before sending it onward.

In some embodiments, when a network node receive a test packet comprising encoded path addressing information and the hop count value is 0, the network node may be preconfigured (e.g., by test controller 102) to perform one or more actions or may detect whether a flag or other value in the test packet indicates one or more “hop count value is zero” actions to perform.

For example, if a network node is not the intended destination of a test packet when the hop count value is 0, the network node may use normal routing techniques (e.g., destination based routing) in sending the test packet onward. In another example, if a network node is not the intended destination of a test packet when the hop count value is 0 and there is a flag value in the packet indicating that a packet drop action is active, the network node may discard the test packet and notify a network operator.

It will be appreciated that FIG. 4 is for illustrative purposes and that details described above in relation to FIG. 4 may be changed, altered, added, or removed. For example, in some embodiments, destination host 302 or an entity thereof may include analyzer 306 or provide similar functionality. In another example, in some embodiments, test controller 102 may act as analyzer 306 or provide similar functionality.

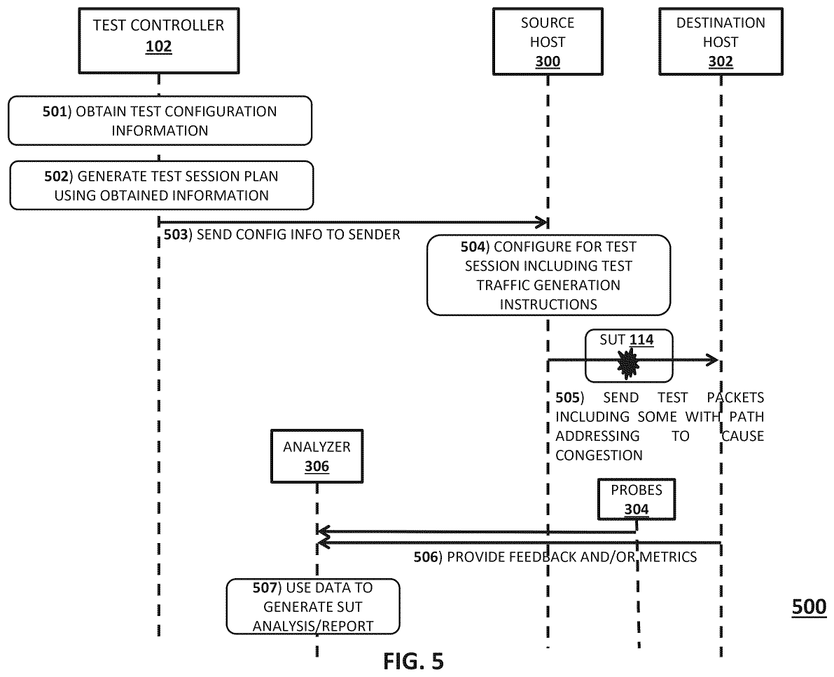

FIG. 5 depicts a message flow diagram 500 related to testing SUT 114. In some embodiments, test system 100 may include entities depicted in FIGS. 1 and 3 and/or may include at least some functionality described above with regard to one or more entities depicted in FIG. 1 or 3. For example, test system 100 may include test controller 102, source host 300, destination host 302, and an analyzer 306. In this example, test system 100 and entities thereof may be implemented on a single device or platform or may be implemented using multiple devices or platforms.

In some embodiments, a test operator (e.g., user 112) may select or provide user input for setting up a test session. For example, user 112 may indicate or provide declarative instructions or a test objective or goal to test controller 102 (e.g., user 112 may indicate to test system 100 that testing should trigger an incast event at a particular SUT switching element). In this example, test controller 102 may automatically configure a test case that involves the use of path addressed test packets (and if desired non-path addressed test traffic, as well) and test controller 102 or a related entity may automatically deploy necessary monitoring infrastructure needed to detect or measure the performance of SUT 114 during the triggered incast event.

Referring to FIG. 5, in step 501, test controller 102 or a related entity may obtain test configuration information and other input (e.g., a user's declarative instruction or a test objective or goal). For example, test configuration information and/or other information may be provided by user 112 via communications interface(s) 108, e.g., a GUI, an API, or other interface.

In some embodiments, test controller 102 or a related entity may be configured to interpret a user's declarative instruction or a test objective or goal into an appropriate test session plan. For example, test controller 102 may automatically determine or generate multiple test traffic flows in order to achieve a particular test objective, where the test traffic flows may comprise a mix of link-encoded complete path addressed test packets, link-encoded partial path addressed test packets, and/or “regular” (e.g., non-path addressed) test packets. In this example, at least some of those path addressed test packets may be for causing or triggering a network condition (e.g., incast congestion, latency, etc.) at an AOI in SUT 114.

In step 502, a test session plan may be generated using the obtained information. For example, test controller 102 or a related entity may generate a test session plan for causing a congestion event at an AOI while testing SUT performance during the congestion event. In this example, test controller 102 may obtain link or node IDs usable for directing test packets via a path and may determine which AOI(s) are to receive these directed test packets and then may generate and insert encoded path addressing information such that the test packets are forwarded or sent to the AOI(s) for causing the congestion event.

In step 503, at least a first configuration message (e.g., a configuration API call, a REST API message, or other message) comprising configuration information for configuring source host 300 or test agent(s) 110 thereof (e.g., a NIC or a traffic generator) to execute a test session or portions thereof. For example, test controller 102 or a related entity may send instructions for generating multiple sets of test traffic including a set of test packets that include path addressing information. In this example, test controller 102 or a related entity may also send instructions indicating when a test session should be executed and/or how source host 300 should generate and insert path addressing information (e.g., an encoded sequence of links or nodes test packets should follow), compute performance metrics, or provide feedback information associated with testing SUT 114.

In step 504, source host 300 or test agent(s) 110 thereof may configure itself using received configuration information (e.g., provided by test controller 102) to generate test packets including test packets that utilize encoded path addressing information to cause or trigger network conditions or test scenarios. For example, source host 300 or test agent(s) 110 thereof may use configuration information to generate test traffic with at least some test packets including path addressing information for causing a network condition and other test packets for performing another test objective or goal (e.g., determining throughput of SUT when experience incast congestion at a particular switch or link in SUT 114).

In step 505, a test session may be performed or initiated where some test packets are sent with path addressing information. For example, after being configured by test controller 102, source host 300 may generate and send test packets comprising path addressing information that causes congestion or another test scenario at an AOI, while also sending additional test packets to or via SUT 114 for testing SUT performance or related aspects.

In step 506, one or more entities (e.g., test agent(s) 110, SUT 114, probes 304, source host 300, destination host 306, etc.) may provide test feedback information. In some embodiments, test agent(s) 110 or probes 304 may be configured to generate metrics or statistics associated with test traffic that traverses SUT 114 and may send this information or related data to test controller 102 or a related entity (e.g., analyzer 306). For example, probes 304 in SUT 114 may indicate which test packets were seen (e.g., as a list of packet identifiers with optional time data), a packet drop metric, and/or a latency metric, while source host 300 may indicate the test packets that were initially sent and destination host 302 may indicate the test packets that were received.

In step 507, analyzer 306 or another entity (e.g., destination host 302, test controller 102, etc.) may receive and analyze test feedback information and generate a test report, performance metrics, or related information. In some embodiments, analyzer 306 or another entity may obtain test feedback data from various entities, including source host 300, destination host 302, and/or probes 304 in SUT 114, and may generate performance reports or test analysis reports using the test feedback data. In this example, assuming time data associated with test packets when test packets were sent, seen, or received, various time related metrics may be computed or used to evaluate SUT performance.

It will be appreciated that FIG. 5 is for illustrative purposes and that various depicted messages and details for testing SUT 114 or aspects thereof described above in relation to FIG. 5 may be changed, altered, added, or removed. It will also be appreciated that various actions described above in relation to FIG. 5 may occur in a different order and/or some of the actions may occur concurrently.

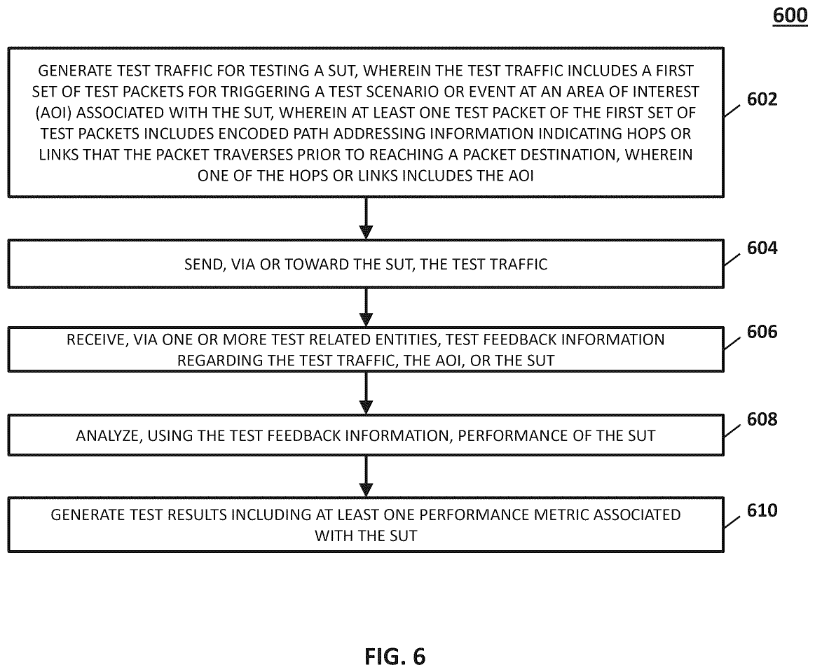

FIG. 6 is a flow chart illustrating an example process 600 for testing SUT 114 using path addressing. In some embodiments, process 600, or portions thereof, may be performed by or at test system 100, test controller 102, and/or another node or module. In some embodiments, process 600 may include steps 602, 604, 606, 608, and/or 610.

In some embodiments, process 600 or portions thereof may occur at test system 100. For example, test controller 102 may generate a test session plan and related configuration information (e.g., API calls, configuration messages, instructions, etc.) for configuring test agent(s) 110 and SUT 114. In this example, test controller 102 may also configure test agent(s) 110 for generating appropriate test traffic using path addressing information to cause or trigger test related scenarios (e.g., network congestion, latency, etc.) for testing SUT 114 or aspects thereof.

Referring to process 600, in step 602, test traffic may be generated for testing a SUT (e.g., SUT 114), wherein the test traffic includes a first set of test packets for triggering a test scenario or event at an AOI (e.g., a super spine switch or a related link of SUT 114) associated with the SUT and at least one test packet of the first set of test packets includes encoded path addressing information indicating hops or links that the packet traverses prior to reaching a packet destination, wherein one of the hops or links may include the AOI. For example, source host 300 may receive configuration instructions for configuring test packet generation including obtaining link IDs and using the link IDs to encode path addressing information for generated test packets.

In some embodiments, a test system (e.g., test system 100) or another entity (e.g., test controller 102) may be configured for (prior to generating test traffic): receiving, from a user, a declarative test objective or user input; and generating, using the declarative test objective or user input, test traffic generation instructions for generating the first set of test packets.

In some embodiments, test traffic generated by a test system (e.g., test system 100) may include a second set of test packets destined for a traffic receiver of the test system that traverses a SUT (e.g., SUT 114).

In some embodiments, a test scenario or event triggered by a first set of test packets (e.g., packets that use path addressing to reach an AOI) may include congestion, latency, link failure, link aggregation failover, or packet drops.

In step 604, the test traffic may be sent via or toward the SUT. For example, source host 300 may forward test packets to a first switch of SUT 114 (e.g., a leaf switch) which may be forwarded along a path (e.g., by path addressing capable nodes) indicated by path addressing information encoded in the test packets.

In step 606, test feedback information regarding the test traffic, the AOI, or the SUT may be received via one or more test related entities, test feedback information regarding the test traffic, the AOI, or the SUT. For example, test related entities may include SUT 114, source host 300, destination host 302, test controller 102, test agent(s) 110, a monitoring agent, or a network probe.

In some embodiments, test related entities may include a test agent, a monitoring agent, or a network probe.

In some embodiments, test feedback information may include packet information, one or more network or link related metrics, or other data.

In step 608, performance of the SUT may be analyzed using the test feedback information. For example, analyzer 306 may receive and analyze feedback information from test agents 110, probes 304, and/or other test related entities.

In step 610, test results including at least one performance metric associated with the SUT may be generated. For example, test system 100, analyzer 306, or another entity may generate a performance metric associated with packet drops or packet latency during a test session where SUT 114 or AOI therein is experiencing congestion caused by test system 100, e.g., using test packets comprising encoded path addressing information.

In some embodiments, encoded path addressing information may indicate an ordered sequence of hop or links identifiers representing a partial or complete path between a first network switch associated with a traffic sender of a test system (e.g., source host 300) and a second network switch associated with a traffic receiver of the test system (e.g., destination host 302).

In some embodiments, encoded path addressing information may indicate one or more actions to perform on at least one test packet or at a hop along a partial or complete path indicated by the path addressing information. For example, encoded actions for a packet may include, but are not limited to, copying the packet, modifying the packet, re-routing via an alternative link or path, dropping or discarding the packet, or converting the packet to a “non-path addressed” format.

In some embodiments, encoded path addressing information may be generated using mapping information that identifies links or hops of a test environment or the SUT. For example, mapping information may be manually provisioned; obtained by actively probing elements of SUT 114; or querying a software defined network controller, a test controller, or a network management node.

In some embodiments, an AOI may include a network switch, a network node, a link, or a link aggregation group.

In some embodiments, a SUT (e.g., SUT 114) may include an ASIC, a NIC, a network switch, a network router, a packet forwarding device, a data center switching environment, a network, or software emulating one or more devices.

It will be appreciated that process 600 may be for illustrative purposes and that different and/or additional actions may be used. It will also be appreciated that various actions described herein may occur in a different order or sequence. Further, it will be appreciated that process 600 or aspects described herein may be useful for testing SUT 114 using path addressing.

It should be noted that test system 100, test controller 102, and/or functionality described herein may constitute a special purpose computing device. Further, test system 100, test controller 102, and/or functionality described herein can improve the technological field of testing SUT 114 or aspects thereof. Furthermore, test system 100, test controller 102, and/or functionality described herein can improve testing of SUT 114 or aspects thereof by utilizing path addressing to direct test traffic to AOIs, thereby effectively causing test related conditions like incast congestion, latency, or network degradation. For example, by generating and sending test packets that include encoded path addressing information for causing the test packets to reach or traverse an AOI in SUT 114, test system 114 can efficiently create a network condition in SUT 114 (e.g., incast congestion) while also sending additional test traffic for testing SUT 114 behavior during the network condition.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for testing a system under test (SUT) using path addressing, the method comprising:
at a test system implemented using at least one processor:
generating test traffic for testing a system under test (SUT), wherein the test traffic includes a first set of test packets for triggering a test scenario or event at an area of interest (AOI) associated with the SUT, wherein at least one test packet of the first set of test packets includes encoded path addressing information indicating hops or links that the packet traverses prior to reaching a packet destination, wherein one of the hops or links includes the AOI;
sending, via or toward the SUT, the test traffic;
receiving, via one or more test related entities, test feedback information regarding the test traffic, the AOI, or the SUT;
analyzing, using the test feedback information, performance of the SUT; and
generating test results including at least one performance metric associated with the SUT.

2. The method of claim 1 comprising:
prior to generating the test traffic:
receiving, from a user, a declarative test objective or user input; and
generating, using the declarative test objective or user input, test traffic generation instructions for generating the first set of test packets.

3. The method of claim 1 wherein the encoded path addressing information indicates an ordered sequence of hop or links identifiers representing a partial or complete path between a first network switch associated with a traffic sender of the test system and a second network switch associated with a traffic receiver of the test system.

4. The method of claim 3 wherein the encoded path addressing information indicates one or more actions to perform on the at least one test packet or at a hop along the partial or complete path.

5. The method of claim 1 wherein the encoded path addressing information is generated using mapping information that identifies links or hops of a test environment or the SUT.

6. The method of claim 5 wherein the mapping information is manually provisioned; obtained by actively probing elements of the SUT; or querying a software defined network controller, a test controller, or a network management node.

7. The method of claim 1 wherein the test related entities include a test agent, a monitoring agent, or a network probe; the test feedback information include packet information, one or more network or link related metrics, or other data; the AOI includes a network switch, a network node, a link, or a link aggregation group; or the SUT includes an application-specific integrated circuit (ASIC), a network interface card (NIC), a network switch, a network router, a packet forwarding device, a data center switching environment, a network, or software emulating one or more devices.

8. The method of claim 1 wherein the test traffic includes a second set of test packets destined for a traffic receiver of the test system that traverses the SUT.

9. The method of claim 1 wherein the test scenario or event triggered by the first set of test packets includes congestion, latency, link failure, link aggregation failover, or packet drops.

10. A system for testing a system under test (SUT) using path addressing, the system comprising:
at least one processor;
a memory; and
a test system implemented using the at least one processor and the memory, the test system configured for:
generating test traffic for testing a system under test (SUT), wherein the test traffic includes a first set of test packets for triggering a test scenario or event at an area of interest (AOI) associated with the SUT, wherein at least one test packet of the first set of test packets includes encoded path addressing information indicating hops or links that the packet traverses prior to reaching a packet destination, wherein one of the hops or links includes the AOI;
sending, via or toward the SUT, the test traffic;
receiving, via one or more test related entities, test feedback information regarding the test traffic, the AOI, or the SUT;
analyzing, using the test feedback information, performance of the SUT; and
generating test results including at least one performance metric associated with the SUT.

11. The system of claim 10 wherein prior to generating the test traffic the test system is configured for:
receiving, from a user, a declarative test objective or user input; and
generating, using the declarative test objective or user input, test traffic generation instructions for generating the first set of test packets.

12. The system of claim 10 wherein the encoded path addressing information indicates an ordered sequence of hop or links identifiers representing a partial or complete path between a first network switch associated with a traffic sender of the test system and a second network switch associated with a traffic receiver of the test system.

13. The system of claim 12 wherein the encoded path addressing information indicates one or more actions to perform on the at least one test packet or at a hop along the partial or complete path.

14. The system of claim 10 wherein the encoded path addressing information is generated using mapping information that identifies links or hops of a test environment or the SUT.

15. The system of claim 14 wherein the mapping information is manually provisioned; obtained by actively probing elements of the SUT; or querying a software defined network controller, a test controller, or a network management node.

16. The system of claim 10 wherein the test related entities include a test agent, a monitoring agent, or a network probe; or the test feedback information include packet information, one or more network or link related metrics, or other data.

17. The system of claim 10 wherein the AOI includes a network switch, a network node, a link, or a link aggregation group; or the SUT includes an application-specific integrated circuit (ASIC), a network interface card (NIC), a network switch, a network router, a packet forwarding device, a data center switching.

18. The system of claim 10 wherein the test traffic includes a second set of test packets destined for a traffic receiver of the test system that traverses the SUT.

19. The system of claim 10 wherein the test scenario or event triggered by the first set of test packets includes congestion, latency, link failure, link aggregation failover, or packet drops.

20. A non-transitory computer readable medium having stored thereon executable instructions embodied in the non-transitory computer readable medium that when executed by at least one processor of a test system cause the test system to perform steps comprising:
generating test traffic for testing a system under test (SUT), wherein the test traffic includes a first set of test packets for triggering a test scenario or event at an area of interest (AOI) associated with the SUT, wherein at least one test packet of the first set of test packets includes encoded path addressing information indicating hops or links that the packet traverses prior to reaching a packet destination, wherein one of the hops or links includes the AOI;
sending, via or toward the SUT, the test traffic;
receiving, via one or more test related entities, test feedback information regarding the test traffic, the AOI, or the SUT;
analyzing, using the test feedback information, performance of the SUT; and
generating test results including at least one performance metric associated with the SUT.
